(19) United States
(12) Patent Application Publication
(10) Pub. No.: US 2025/0291379 A1
(43) Pub. Date: Sep. 18, 2025

(54) System and Method for Providing High-Frequency Anti-Tamper Protection in Communication Interface

(71) Applicant: Microchip Technology Incorporated, Chandler, AZ (US)

(72) Inventor: Robin Jonah Solomon, Chennai (IN)

(73) Assignee: Microchip Technology Incorporated, Chandler, AZ (US)

(21) Appl. No.: 19/078,594

(22) Filed: Mar. 13, 2025

(30) Foreign Application Priority Data
Mar. 14, 2024 (IN) 202441018433

(51) Int. Cl. G06F 1/04

(52) U.S. Cl. CPC G06F 1/04

(57) ABSTRACT

Systems, methods, and apparatuses include a first counter to count a number of clock pulses received by the communication interface within a predetermined time window, a second counter pre-loaded with a predetermined count value indicating a threshold number of clock pulses expected to be received within the predetermined time window, and a comparator to compare a count value of the second counter to the threshold number of clock pulses. Control circuitry may enable the first counter when a chip select signal is asserted, disable the first counter when the chip select signal is de-asserted, start the second counter when a clock pulse is received, stop the second counter when a predetermined number of clock pulses have been received, and trigger a tamper signal if the count value of the second counter is greater than the threshold number of clock pulses.

### CROSS-REFERENCE TO RELATED APPLICATION

The present application claims priority to Indian Provisional Patent Application No. 202441018433, filed on Mar. 14, 2024, which is incorporated herein in its entirety.

### TECHNICAL FIELD

The present disclosure relates generally to communication interfaces, and more specifically to a system and method to provide high-frequency anti-tamper protection in a communication interface.

### SUMMARY

According to an aspect of one or more examples, there is provided a system to provide high-frequency anti-tamper protection in a communication interface. The system may include a first counter to count a number of clock pulses received by the communication interface within a predetermined time window, a second counter pre-loaded with a predetermined count value indicating a threshold number of clock pulses expected to be received within the predetermined time window, a comparator to compare a count value of the second counter to the threshold number of clock pulses, and a control circuitry. The control circuitry may enable the first counter when a chip select signal is asserted. The control circuitry may disable the first counter when the chip select is de-asserted. The control circuitry may start the second counter when a clock pulse is received. The control circuitry may stop the second counter when a predetermined number of clock pulses have been received. The control circuitry may trigger a tamper signal if the count value of the second counter is greater than the threshold number of clock pulses.

The predetermined number of clock pulses may be about 6 pulses, where the predetermined number of clock pulses correspond to a number of clock cycles to occur at corresponding frequencies of the communication interface. The threshold number of clock pulses may be 0. The predetermined time window may be defined by a clock domain with a 384-MHz sampling frequency. The control circuitry may operate with a full clock synchronizer. The control circuitry may operate with a half clock synchronizer. The system may include a logic circuitry to terminate a data transfer on the communication interface when the tamper signal is triggered. The control circuitry may reset the second counter to zero when the chip select signal is de-asserted. The system may include an application processor. The tamper signal may trigger a reset signal for the application processor or an interrupt signal to the application processor. The predetermined count value may correspond to a maximum allowed number of clock pulses within the predetermined time window. The number of clock pulses may be incremented until a terminal condition is triggered. The predetermined count value may be decremented by the second counter when respective clock pulses of the number of clock pulses are received from the first counter.

According to an aspect of one or more examples, there is provided a method to provide high-frequency anti-tamper protection in a communication interface. The method may include monitoring, by a first counter, a number of clock pulses received within a predetermined time window, pre-loading a second counter with a predetermined count value indicating a threshold number of clock pulses expected to be received within the predetermined time window, starting the second counter when a clock pulse is received, comparing a count value of the second counter to the threshold number of clock pulses after receiving a predetermined number of clock pulses and triggering a tamper signal if the count value of the second counter is greater than threshold number of clock pulses.

The predetermined number of clock pulses may be about 6 pulses, where the predetermined number of clock pulses corresponds to a number of clock cycles to occur at corresponding frequencies of the communication interface. The threshold number of clock pulses may be 0. The predetermined time window may be defined by a clock domain with a 384-MHz sampling frequency. The method may include terminating a data transfer on the communication interface when the tamper signal is triggered. The method may include resetting the second counter when a chip select signal is de-asserted. The method may include triggering a reset signal for an application processor or an interrupt signal to the application processor when the tamper signal is triggered. The predetermined count value may correspond to a maximum allowed number of clock pulses within the predetermined time window.

According to an aspect of one or more examples, there is provided an apparatus that may include a communication interface for communicating with one or more peripheral devices, a first counter to count a number of clock pulses received by the communication interface within a predetermined time window, and a second counter pre-loaded with a predetermined count value indicating a threshold number of clock pulses expected to be received within the predetermined time window. The apparatus may also include a comparator to compare a count value of the second counter to the threshold number of clock pulses and a control circuitry to enable the first counter when a chip select signal is asserted, disable the first counter when the chip select signal is de-asserted, start the second counter when a clock pulse is received, stop the second counter when a predetermined number of clock pulses have been received, and trigger a tamper signal if the count value of the second counter is greater than the threshold number of clock pulses.

### BRIEF DESCRIPTION OF DRAWINGS

FIG. 1 shows a block diagram illustrating a system for providing high-frequency anti-tamper protection in a communication interface according to one or more examples.

FIG. 2 shows a flowchart illustrating a method for providing the high-frequency anti-tamper protection in the communication interface according to one or more examples.

FIG. 3 shows a first table illustrating frequency response using a full clock synchronizer at 384-Megahertz sampling frequency according to one or more examples.

### DETAILED DESCRIPTION OF VARIOUS EXAMPLES

Reference will now be made in detail to the following various examples, which are illustrated in the accompanying drawings, wherein like reference numerals refer to like elements throughout. The following examples may be embodied in various forms without being limited to the examples set forth herein.

Some microcontrollers allow serial peripheral interface flash operation up to 50 Megahertz, which when exceeded may potentially bypass existing security monitors, allowing unauthorized access to protected regions of the memory. Therefore, shortcomings of existing processes may be addressed through a system and method that may provide high-frequency anti-tamper protection in a serial peripheral interface bus.

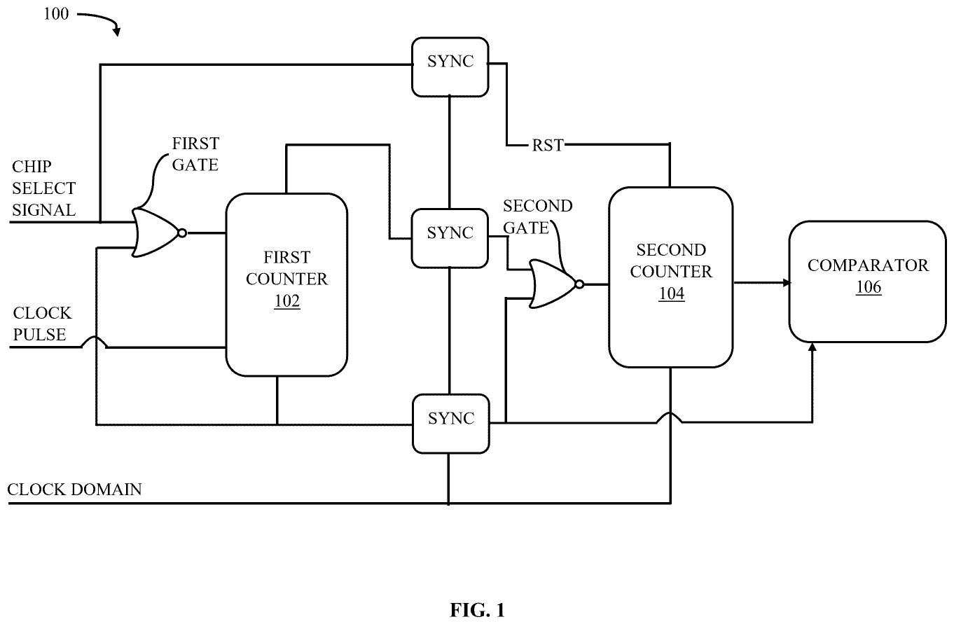

FIG. 1 shows a block diagram illustrating a system 100 for providing high-frequency anti-tamper protection in a communication interface according to one or more examples. In one or more example, the communication interface may be a serial peripheral interface (SPI), an inter-integrated circuit, or any other suitable communication interface. The system 100 leverages a combination of hardware components and control logic that may detect and prevent potential security vulnerabilities associated with unauthorized high-frequency access attempts to a Flash memory. The system 100 may include a first counter 102, a second counter 104, a comparator 106, and a control circuitry (not shown). The control circuitry may operate with a full clock synchronizer or a half clock synchronizer.

The first counter 102 may monitor a number of clock pulses received within a predetermined time window. The number of clock pulses may correspond to a total count of clock pulses occurring during a communication session. The predetermined time window may correspond to a specific duration measured in clock cycles during which the first counter 102 may monitor the number of clock pulses. In one or more examples, the predetermined time window may be defined by a clock domain selected from a set of frequencies including 384 Megahertz. The predetermined time window may leverage the clock domain to establish the duration of the time window in clock cycles. The predetermined time window may be programmable to provide flexibility through the selection of the clock domain based on responsiveness of the high-frequency anti-tamper protection. The predetermined time window may act as a reference point for a maximum allowed number of clock pulses. An excessive number of clock pulses received within the predetermined time window may trigger a security response, indicating a potential attempt to bypass security measures in the communication interface.

The clock pulse may be a synchronizing signal used to coordinate the data transfer between a master device and one or more slave devices in the communication session. The data transfer between the master device and the one or more slave devices may occur on one or more edges (e.g., rising edge or falling edge) of the clock pulse. The master device may generate the clock pulse and transmit the clock pulse to the one or more slave devices. The one or more slave devices may read the data transmitted by the master device on the rising edge or falling edge of the clock pulse.

In various examples, the first counter 102 may be a 3-bit counter (though a different number of bits may be used) to monitor the number of clock pulses received within the predetermined time window. The three-bit counter may have a capacity to hold a value between 0 and 7. The first counter 102 may be operated through the control circuitry and facilitate the detection of the unauthorized high-frequency access attempts on the communication interface. The first counter 102 may count the number of clock pulses received within the predetermined time window. The control circuitry may enable the first counter 102 when a chip select signal is asserted. The chip select signal may indicate start of the communication session between the system 100 and the flash memory when asserted. The chip select signal may trigger a first gate (explicitly shown in FIG. 1) when asserted. The first gate may be a NOR gate. The first gate may enable the first counter 102 when the chip select signal is asserted, which may allow the first counter 102 to start accumulating the clock pulse. The chip select signal may be de-asserted when the communication session is concluded between the system 100 and the flash memory, which may indicate end of the data transfer and the first counter 102 may be disabled.

The first counter 102 may include an enable count signal (ₑₙCNT). The first counter 102 may be enabled when the enable count signal is low (ₑₙCNT==0). The first counter 102 may depend on a clock signal (CLK) to drive an incrementing process of the first counter 102. The incrementing process may increment the value of the clock signal by 1 when the first counter 102 is enabled. The first counter 102 may have a terminal condition (_{tc}CNT==7). The terminal condition may allow the first counter 102 to stop the incrementing process at a count value of 6. The first counter 102 may be enabled when the terminal condition is not asserted and the chip select signal is asserted. The first counter 102 may be reset when the chip select signal is de-asserted to an initial value of 0. The reset of the first counter 102 may enable the first counter 102 to start accumulating pulses for a new communication session. The first counter 102 may function as an up counter, incrementing the value by 1 with the rising edge of the clock signal. The first counter 102 may utilize the terminal condition to create a 6-pulse window for measurement within the predetermined time window based on the clock domain. The 6-pulse window may align with a predetermined number of clock pulses. The predetermined number of clock pulses may be about 6 pulses.

The second counter 104 may be pre-loaded with a predetermined count value. The predetermined count value may correspond to a maximum allowed number of clock pulses within the predetermined time window based on the clock domain. The second counter 104 may function as a down counter with a synchronous reset. The control circuit may enable the second counter 104 to decrement the predetermined count value by 1 when the clock pulse is received. The control circuitry may reset the second counter 104 to zero when the chip select is de-asserted, which indicates the end of the communication session. The second counter 104 may receive the clock pulse from the first counter 102 through a second gate. The second gate may be a NOR gate. The decrement process of the second counter 104 may begin when the clock pulse is received and the chip select signal is asserted. The second counter 104 may be stopped when the predetermined number of clock pulses is received and check a value of the second counter 104.

The comparator 106 may receive the value of the second counter 104. The value of the second counter may represent the remaining number of allowed clock pulses within the predetermine time window. The comparator is 106 may be pre-loaded with a predetermined threshold value. The predetermined threshold value may be 0. The comparator 106 may compare the value of the second counter 104 with the predetermined threshold value. The control circuitry may trigger a tamper signal when the value of the second counter 104 is greater than the predetermined threshold value according to the comparator 106 after receiving the maximum allowed number of clock pulses. It may signify that the received clock pulses exceed the maximum allowed number of clock pulses within the predetermined time window. However, if the value of the second counter 104 is equal to the predetermined threshold value, it is a communication session without the unauthorized high-frequency access attempts.

The system 100 may include a logic circuitry (not shown) to terminate the data transfer on the communication interface when the tamper signal is triggered. The logic circuitry may assert control signals (e.g., the chip select signal, clock pulse) to a low logic level to halt the communication session to terminate the data transfer. The logic circuitry may generate a bus hold signal that propagates throughout the system 100, to instruct devices on the communication interface to halt the communication session. The logic circuitry may interact with the control circuitry responsible to manage the communication interface. The logic circuitry may instruct the control circuitry to stop the first counter 102 and the second counter 104, to prevent processing of the unauthorized high-frequency access attempts. The system 100 may include an application processor (not shown). The tamper signal may trigger a reset signal for the application processor or an interrupt signal to the application processor. The tamper signal may serve a notification mechanism for the application processor.

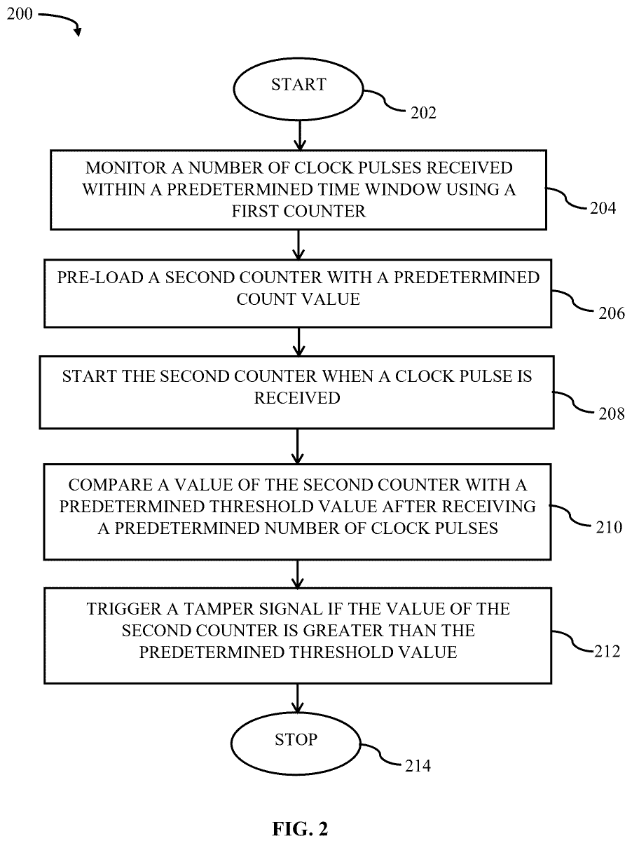

FIG. 2 shows a flowchart 200 illustrating a method for providing the high-frequency anti-tamper protection in the communication interface according to one or more examples. It may be noted that in order to explain the method operations of the flowchart 200, references will be made to the elements explained in FIG. 1.

The flowchart 200 starts at operation 202. At operation 204, the method may include monitoring the number of clock pulses received within the predetermined time window using the first counter 102. At operation 206, the method may include pre-loading the second counter 104 with the predetermined count value. At operation 208, the method may include starting the second counter 104 when the clock pulse is received. At operation 210, the method may include comparing the value of the second counter 104 with the predetermined threshold value after receiving the predetermined number of clock pulses. At operation 212, the method may include triggering the tamper signal if the value of the second counter 104 is greater than the predetermined threshold value.

The flowchart 200 terminates at operation 214. It may be noted that the flowchart 200 is explained to have above stated process operations; however, those skilled in the art would appreciate that the flowchart 200 may have more/less number of process operations which may enable all the above stated examples of the present disclosure.

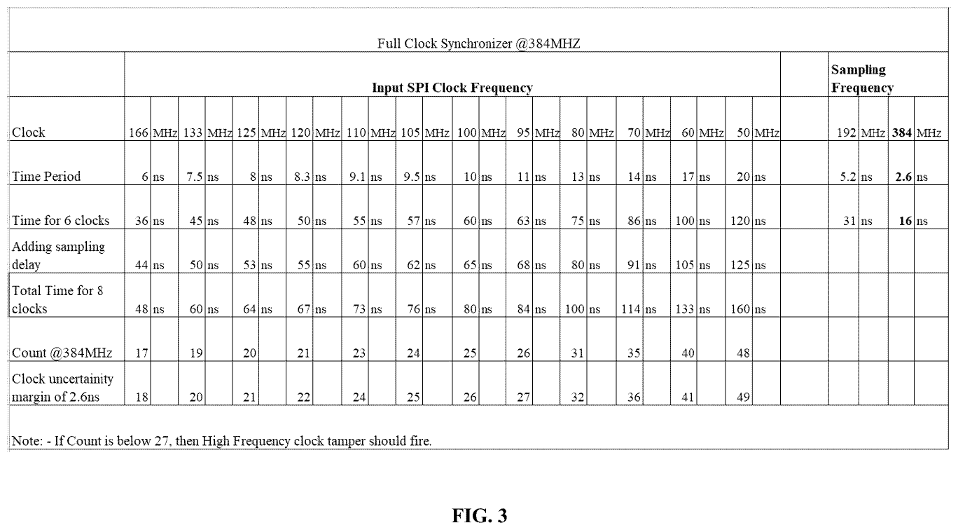

FIG. 3 shows a table illustrating frequency response using a full clock synchronizer at 384-Megahertz sampling frequency according to one or more examples. The table of FIG. 3 details how using full clock synchronizer at 384-Megahertz sampling frequency, the system 100 reacts to a plurality of input SPI clock frequencies that may be encountered on the communication interface. The table represents a plurality of parameters for each of the plurality of input SPI clock frequencies. The plurality of parameters may include a time period, a time for 6 clocks, an adding sampling delay, a total time for 8 clocks, a count at the clock domain of about 384 Megahertz and a clock uncertainty margin of about 2.6 nanoseconds (one clock period).

The time value may correspond to a duration of a single clock cycle for corresponding input SPI clock frequencies. The time for 6 clocks may correspond to a total time taken for six clock cycles to occur at the corresponding input SPI clock frequencies. The adding sampling delay may correspond to a potential delay introduced by the sampling process within the full clock synchronizer for the corresponding input SPI clock frequencies. The clock uncertainty margin may account for potential variation in the clock signal. The count at the clock domain of about 384 Megahertz with the clock uncertainty margin is about 26 for 100 Megahertz of the input SPI clock frequency. Therefore, the tamper signal may be triggered if the count is below 27 to avoid the input SPI clock frequency of about 100 Megahertz and above.

Various examples have been disclosed herein, in connection with the above description and the drawings. It will be understood that it would be unduly repetitious to literally describe and illustrate all possible combinations or subcombinations of these examples. Accordingly, all examples can be combined in any way or combination, without limitation, and the present specification, including the drawings, shall be construed to constitute a complete written description of all combinations and subcombinations of these examples herein, and of the manner and process of making and using them, and shall support claims to any such combination or subcombination.

It will be appreciated by persons skilled in the art that the examples described herein are not limited to what has been particularly shown and described herein above. In addition, unless mention was made above to the contrary, the accompanying drawings are not to scale. A variety of modifications and variations are possible in light of the above teachings.

What is claimed is:

1. A system for providing high-frequency anti-tamper protection in a communication interface, the system comprising:
a first counter to count a number of clock pulses received by the communication interface within a predetermined time window;
a second counter pre-loaded with a predetermined count value indicating a threshold number of clock pulses expected to be received within the predetermined time window;
a comparator to compare a count value of the second counter to the threshold number of clock pulses; and
a control circuitry to:
enable the first counter when a chip select signal is asserted;
disable the first counter when the chip select signal is de-asserted;
start the second counter when a clock pulse is received;
stop the second counter when a predetermined number of clock pulses have been received; and
trigger a tamper signal if the count value of the second counter is greater than the threshold number of clock pulses.

2. The system of claim 1, wherein the predetermined number of clock pulses is about 6 pulses, the predetermined number of clock pulses corresponding to a number of clock cycles to occur at corresponding frequencies of the communication interface.

3. The system of claim 1, wherein the threshold number of clock pulses is 0.

4. The system of claim 1, wherein the predetermined time window is defined by a clock domain with a 384 MHz sampling frequency.

5. The system of claim 1, wherein the control circuitry is to operate with a full clock synchronizer.

6. The system of claim 1, wherein the control circuitry is to operate with a half clock synchronizer.

7. The system of claim 1, further comprising a logic circuitry to terminate a data transfer on the communication interface when the tamper signal is triggered.

8. The system of claim 1, wherein the control circuitry is to reset the second counter to zero when the chip select signal is de-asserted.

9. The system of claim 1, further comprising an application processor, wherein the tamper signal is to trigger a reset signal for the application processor or an interrupt signal to the application processor.

10. The system of claim 1, wherein the predetermined count value corresponds to a maximum allowed number of clock pulses within the predetermined time window.

11. The system of claim 1, wherein the number of clock pulses is to be incremented until a terminal condition is triggered.

12. The system of claim 1, wherein the predetermined count value is to be decremented by the second counter when respective clock pulses of the number of clock pulses are received from the first counter.

13. A method for providing high-frequency anti-tamper protection in a communication interface, the method comprising:
monitoring, by a first counter, a number of clock pulses received within by the communication interface a predetermined time window;
pre-loading a second counter with a predetermined count value indicating a threshold number of clock pulses expected to be received within the predetermined time window;
starting the second counter when a clock pulse is received;
comparing a count value of the second counter to the threshold number of clock pulses after receiving a predetermined number of clock pulses; and
triggering a tamper signal if the count value of the second counter is greater than the threshold number of clock pulses.

14. The method of claim 13, wherein the predetermined number of clock pulses is about 6 pulses, the predetermined number of clock pulses corresponding to a number of clock cycles to occur at corresponding frequencies of the communication interface.

15. The method of claim 13, wherein the threshold number of clock pulses is 0.

16. The method of claim 13, wherein the predetermined time window is defined by a clock domain with a 384 MHz sampling frequency.

17. The method of claim 13, further comprising terminating a data transfer on the communication interface when the tamper signal is triggered.

18. The method of claim 13, further comprising resetting the second counter when a chip select signal is de-asserted.

19. The method of claim 13, further comprising triggering a reset signal for an application processor or an interrupt signal to the application processor when the tamper signal is triggered.

20. An apparatus, comprising:
a communication interface for communicating with one or more peripheral devices;
a first counter to count a number of clock pulses received by the communication interface within a predetermined time window;
a second counter pre-loaded with a predetermined count value indicating a threshold number of clock pulses expected to be received within the predetermined time window;
a comparator to compare a count value of the second counter to the threshold number of clock pulses; and
a control circuitry to:
enable the first counter when a chip select signal is asserted;
disable the first counter when the chip select signal is de-asserted;
start the second counter when a clock pulse is received;
stop the second counter when a predetermined number of clock pulses have been received; and
trigger a tamper signal if the count value of the second counter is greater than the threshold number of clock pulses.
